(19) United States
(12) Patent Application Publication
(10) Pub. No.: US 2022/0415094 A1
(43) Pub. Date: Dec. 29, 2022

(54) METHOD AND SYSTEM FOR ESTIMATING GESTURE OF USER FROM TWO-DIMENSIONAL IMAGE, AND NON-TRANSITORY COMPUTER-READABLE RECORDING MEDIUM

(71) Applicant: VTOUCH CO., LTD., Seoul (KR)

(72) Inventors: Seok Joong KIM, Seoul (KR); Jik Han JUNG, Yongin-si (KR)

(73) Assignee: VTOUCH CO., LTD., Seoul (KR)

(21) Appl. No.: 17/903,142

(22) Filed: Sep. 6, 2022

Related U.S. Application Data
(63) Continuation of application No. PCT/KR2021/002480, filed on Feb. 26, 2021.

(30) Foreign Application Priority Data
Mar. 3, 2020 (KR) 10-2020-0026774

(51) Int. Cl. G06V 40/20; G06T 7/246; G06F 3/01

(52) U.S. Cl. CPC G06V 40/28; G06T 7/251; G06F 3/017

(57) ABSTRACT

There is provided a method of estimating a gesture of a user from a two-dimensional image. The method includes the steps of: acquiring a two-dimensional image relating to a user's body from a two-dimensional camera; specifying two-dimensional relative coordinate points corresponding first and second body parts of the user in a relative coordinate system dynamically defined in the two-dimensional image, and comparing a first positional relationship between the two-dimensional relative coordinate points of the first and second body parts at a first time point, and a second positional relationship between the two-dimensional relative coordinate points of the first and second body parts at a second time point; and estimating the gesture made by the user between the first and second time points based on the result of comparing and context information acquired from the two-dimensional image.

### CROSS-REFERENCE TO RELATED APPLICATIONS

This application is a continuation application of Patent Cooperation Treaty (PCT) International Application No. PCT/KR2021/002480 filed on Feb. 26, 2021, which claims priority to Korean Patent Application No. 10-2020-0026774 filed on Mar. 3, 2022. The entire contents of PCT International Application No. PCT/KR2021/002480 is hereby incorporated by reference.

### TECHNICAL FIELD

The present disclosure relates to a method, system, and non-transitory computer-readable recording medium for estimating a gesture of a user from a two-dimensional image.

### BACKGROUND

In recent years, technologies for controlling objects or executing instructions by recognizing user's gestures in various use environments, such as mobile devices, tablets, laptops, personal computers (PCs), home appliances, automobiles, and the like have been introduced.

As an example of related conventional techniques, Korean Laid-Open Patent Publication No. 10-2012-126508 discloses a method for recognizing a touch in a virtual touch device without using a pointer, wherein the virtual touch device comprises: an image acquisition unit composed of two or more image sensors disposed at different positions and configured to photograph a user's body in front of a display surface; a spatial coordinate calculation unit configured to calculate three-dimensional coordinate data of the user's body using an image received from the image acquisition unit; a touch position calculation unit configured to use first and second spatial coordinates received from the spatial coordinate calculation unit to calculate coordinate data of a contact point where a straight line connecting the first and second spatial coordinates meets the display surface; and a virtual touch processing unit configured to generate a command code for performing an operation corresponding to the contact point coordinate data received from the touch position calculation unit and input the command code to a main control unit of an electronic apparatus, and wherein the method comprises the steps of: (a) processing three-dimensional coordinate data (X1, Y1, Z1) of a fingertip and three-dimensional coordinate data (X2, Y2, Z2) of a center point of an eye to detect a contact point A of the eye, a fingertip point B, and a display surface C, respectively; (b) calculating at least one of a depth change, a trajectory change, a holding time, and a change rate of the detected fingertip point; and (c) causing the electronic apparatus to be operated or causing an area corresponding to a touched part of a touch panel to be selected, on the basis of the at least one of the depth change, the trajectory change, the holding time, and the change rate of the fingertip point.

According to techniques introduced so far as well as the above-described conventional technique, a process of acquiring three-dimensional coordinates of a user's body portions using a three-dimensional camera is essentially required in order to recognize a user's gesture for selecting or controlling an object. However, the three-dimensional camera is not only expensive but also causes a lot of delays in the course of processing three-dimensional data. A central processing unit (CPU) or the like with higher performance is required to address the delays, resulting in lower overall efficiency.

Alternatively, techniques for recognizing a user's gesture using a two-dimensional camera such as an RGB camera, an infrared (IR) camera, or the like have been introduced. However, with the two-dimensional camera, it is difficult to detect a distance to a capturing target or a difference in depth between capturing targets. As a result, there is still a technical limit that it is difficult to recognize a gesture based on movements of the user in a forward-backward direction using a two-dimensional image acquired from the two-dimensional camera.

Based on the above findings, the present inventors present a novel and improved technique which is capable of accurately estimating a user's gesture performed in a three-dimensional space by merely using a two-dimensional image acquired by capturing of a two-dimensional camera.

### SUMMARY

One object of the present disclosure is to solve all the above-described problems in the prior art.

Another object of the present disclosure is to accurately estimate a user's gesture performed in three-dimensional space by merely using information acquired by a two-dimensional camera that is typically provided for an electronic device without using a precision sensing means such as a three-dimensional camera.

Yet another object of the present disclosure is to efficiently estimate a user's gesture using a smaller amount of resource and thus efficiently recognize a control intention of the user.

Still another object of the present disclosure is to more accurately estimate a user's gesture using a machine learning model learned based on information acquired from a two-dimensional image.

Representative configurations of the present disclosure to achieve the above objects are described below.

According to one aspect of the present disclosure, there is provided a method of estimating a gesture of a user from a two-dimensional image, comprising the steps of: acquiring a two-dimensional image relating to a user's body from a two-dimensional camera; specifying two-dimensional relative coordinate points corresponding to a first body part and a second body part of the user in a relative coordinate system dynamically defined in the two-dimensional image, and comparing a first positional relationship between the two-dimensional relative coordinate point of the first body part and the two-dimensional relative coordinate point of the second body part at a first time point, and a second positional relationship between the two-dimensional relative coordinate point of the first body part and the two-dimensional relative coordinate point of the second body part at a second time point; and estimating the gesture made by the user between the first time point and the second time point with reference to a result of the comparing and context information acquired from the two-dimensional image.

According to another aspect of the present disclosure, there is provided a system for estimating a gesture of a user from a two-dimensional image, comprising: an image acquisition unit configured to acquire the two-dimensional image relating to the user's body from a two-dimensional camera; and a gesture estimation unit configured to: specify two-dimensional relative coordinate points corresponding to a first body part and a second body part of the user in a relative coordinate system dynamically defined in the two-dimensional image; compare a first positional relationship between the two-dimensional relative coordinate point of the first body part and the two-dimensional relative coordinate point of the second body part at a first time point, and a second positional relationship between the two-dimensional relative coordinate point of the first body part and the two-dimensional relative coordinate point of the second body part at a second time point; and estimate the gesture made by the user between the first time point and the second time point with reference to a result of the comparing and context information acquired from the two-dimensional image.

There are further provided other methods and systems to implement the present disclosure, as well as non-transitory computer-readable recording media having stored thereon computer programs for executing the methods.

According to the present disclosure, it is possible to accurately estimate a user's gesture performed in three-dimensional space by merely using information acquired from a two-dimensional camera that is typically provided for an electronic device, without using a precision sensing means such as a three-dimensional camera.

Further, according to the present disclosure, it is possible to efficiently estimate a user's gesture using a smaller amount of resource and thus efficiently recognize a control intention of a user.

Furthermore, according to the present disclosure, it is possible to more accurately estimate a user's gesture using a machine learning model learned based on information acquired from a two-dimensional image.

### BRIEF DESCRIPTION OF THE DRAWINGS

FIG. 1 illustratively shows an internal configuration of a gesture estimation system according to one embodiment of the present disclosure.

FIG. 2A illustratively shows a two-dimensional image in which a user makes a gesture with respect to a two-dimensional camera according to one embodiment of the present disclosure.

FIG. 2B illustratively shows a two-dimensional image in which a user makes a gesture with respect to a two-dimensional camera according to one embodiment of the present disclosure.

FIG. 3A illustratively shows a two-dimensional image in which a user makes a gesture with respect to a two-dimensional camera according to one embodiment of the present disclosure.

FIG. 3B illustratively shows a two-dimensional image in which a user makes a gesture with respect to a two-dimensional camera according to one embodiment of the present disclosure.

FIG. 4 illustratively shows a two-dimensional image in which a user makes a gesture with respect to the two-dimensional camera with reference to a polar coordinate system according to one embodiment of the present disclosure.

FIG. 5 illustratively shows a two-dimensional image in which a user makes a gesture with respect to the two-dimensional camera with reference to a polar coordinate system according to one embodiment of the present disclosure.

FIG. 6 illustratively shows a two-dimensional image in which a user makes a gesture with respect to the two-dimensional camera with reference to a polar coordinate system according to one embodiment of the present disclosure.

FIG. 7A illustratively shows a two-dimensional image in which a user makes a gesture to move his/her finger toward the two-dimensional camera according to one embodiment of the present disclosure.

FIG. 7B illustratively shows a two-dimensional image in which a user makes a gesture to move his/her finger toward the two-dimensional camera according to one embodiment of the present disclosure.

FIG. 8 illustratively shows a two-dimensional image in which a user makes a gesture with respect to a surrounding object according to one embodiment of the present disclosure

FIG. 9 illustratively shows a two-dimensional image in which a user makes a gesture with respect to a surrounding object according to one embodiment of the present disclosure

FIG. 10A illustratively shows a two-dimensional image in which a user makes a gesture to move his/her finger toward a surrounding object according to one embodiment of the present disclosure.

FIG. 10B illustratively shows a two-dimensional image in which a user makes a gesture to move his/her finger toward a surrounding object according to one embodiment of the present disclosure.

FIG. 10C illustratively shows a two-dimensional image in which a user makes a gesture to move his/her finger toward a surrounding object according to one embodiment of the present disclosure.

FIG. 10D illustratively shows a two-dimensional image in which a user makes a gesture to move his/her finger toward a surrounding object according to one embodiment of the present disclosure.

FIG. 11 illustratively shows a two-dimensional image in which a user makes a gesture with respect to a surrounding object according to one embodiment of the present disclosure.

FIG. 12 illustratively shows a two-dimensional image in which a user makes a gesture with respect to a surrounding object according to one embodiment of the present disclosure.

FIG. 13 illustratively shows a two-dimensional image in which a user makes a gesture with respect to a surrounding object according to one embodiment of the present disclosure.

FIG. 14 illustratively shows a two-dimensional image in which a user makes a gesture with respect to a surrounding object according to one embodiment of the present disclosure.

### DETAILED DESCRIPTION

In the following detailed description of the present disclosure, references are made to the accompanying drawings that show, by way of illustration, specific embodiments in which the present disclosure may be practiced. These embodiments are described in sufficient detail to enable those skilled in the art to practice the present disclosure. It is to be understood that the various embodiments of the present disclosure, although different from each other, are not necessarily mutually exclusive. For example, specific shapes, structures and characteristics described herein may be implemented as modified from one embodiment to another without departing from the spirit and scope of the present disclosure. Furthermore, it shall be understood that the positions or arrangements of individual elements within each of the embodiments may also be modified without departing from the spirit and scope of the present disclosure. Therefore, the following detailed description is not to be taken in a limiting sense, and the scope of the present disclosure is to be taken as encompassing the scope of the appended claims and all equivalents thereof. In the drawings, like reference numerals refer to the same or similar elements throughout the several views.

Hereinafter, various preferred embodiments of the present disclosure will be described in detail with reference to the accompanying drawings to enable those skilled in the art to easily implement the present disclosure.

Configuration of the Entire System

A system according to one embodiment of the present disclosure may be configured to include a communication network, a gesture estimation system 100, and a two-dimensional camera.

First, the communication network according to one embodiment of the present disclosure may be configured without taking a usual aspect such as wired or wireless communication into account, and may include a variety of communication networks such as a local area network (LAN), a metropolitan area network (MAN), and a wide area network (WAN). Preferably, the communication network described herein may be the Internet or the World Wide Web (WWW). However, the communication network is not necessarily limited thereto, and may at least partially include known wired/wireless data communication networks, known telephone networks, or known wired/wireless television communication networks.

For example, the communication network may be a wireless data communication network, at least a part of which may be implemented with a conventional communication scheme such as radio frequency (RF) communication, WiFi communication, cellular communication (e.g., Long Term Evolution (LTE) communication), Bluetooth communication (more specifically, Bluetooth Low Energy (BLE) communication), infrared communication, and ultrasonic communication.

Next, the gesture estimation system 100 according to one embodiment of the present disclosure may be a digital device having a memory means and a microprocessor for computing capabilities. The gesture estimation system 100 may be a server system.

According to one embodiment of the present disclosure, the gesture estimation system 100 may be connected to a two-dimensional camera to be described below via the communication network or a processor (not shown), and may function to: acquire a two-dimensional image relating to a user's body from the two-dimensional camera; specify two-dimensional relative coordinate points corresponding to each of a first body part and a second body part of the user in a relative coordinate system that is dynamically defined in the two-dimensional image and compare a positional relationship between the two-dimensional relative coordinate point of the first body part and the two-dimensional relative coordinate point of the second body part at a first time point, and a positional relationship between the two-dimensional relative coordinate point of the first body part and the two-dimensional relative coordinate point of the second body part at a second time point; and estimate a gesture made by the user between the first time point and the second time point with reference to the above comparison result and context information acquired from the two-dimensional image.

Here, the two-dimensional relative coordinate points according to one embodiment of the present disclosure may be coordinate points specified in the relative coordinate system that is dynamically defined in the two-dimensional image obtained from the two-dimensional camera.

For example, the relative coordinate system according to one embodiment of the present disclosure may be a two-dimensional orthogonal coordinate system or a two-dimensional polar coordinate system that is dynamically defined with reference to a position of the first body part of the user that appears on the two-dimensional image captured by the two-dimensional camera.

Specifically, according to one embodiment of the present disclosure, when the relative coordinate system dynamically defined in the two-dimensional image is the two-dimensional orthogonal coordinate system, the two-dimensional relative coordinate points of the first body part and the second body part may be specified in a format such as (x, y). When the relative coordinate system dynamically defined in the two-dimensional image is the two-dimensional polar coordinate system, the two-dimensional relative coordinate points of the first body part and the second body part may be specified in a format such as (r, θ).

According to one embodiment of the present disclosure, the first body part or the second body part that may be specified in the two-dimensional image may include a head, an eye (a dominant eye), a nose, a mouth, a hand, a fingertip, a finger, an arm (a forearm and an upper arm), a foot, a foot tip, a toe, a leg, or the like. However, the present disclosure is not limited to the body parts described above. The first body part or the second body part may be changed to other various body parts as long as the aspects of the present disclosure may be achieved. Further, according to one embodiment of the present disclosure, if an object (e.g., a pointer held by the user's hand, or the like) other than the user's body part is necessary to estimate a user's gesture, the object may be considered similar to the user's body part and two-dimensional relative coordinate points of the object may be specified in the two-dimensional image.

The configuration and functions of the gesture estimation system 100 according to the present disclosure will be described in more detail below. Meanwhile, although the gesture estimation system 100 has been described as above, such a description is illustrative and it will be apparent to those skilled in the art that at least a part of functions or components required for the gesture estimation system 100 may be implemented or included in an external device (e.g., a mobile device, a wearable device, or the like held by the user) or an external system (e.g., a cloud server, or the like), as necessary.

Next, the two-dimensional camera (not shown) according to one embodiment of the present disclosure may be in communication with the gesture estimation system 100 by the communication network or the processor, and may perform a function of acquiring the two-dimensional image relating to the user's body. For example, the two-dimensional camera according to one embodiment of the present disclosure may include various types of capturing modules such as an RGB camera, an IR camera, or the like.

Configuration of the Gesture Estimation System

Hereinafter, an internal configuration of the gesture estimation system 100 crucial for implementing the present disclosure and functions of respective components thereof will be described.

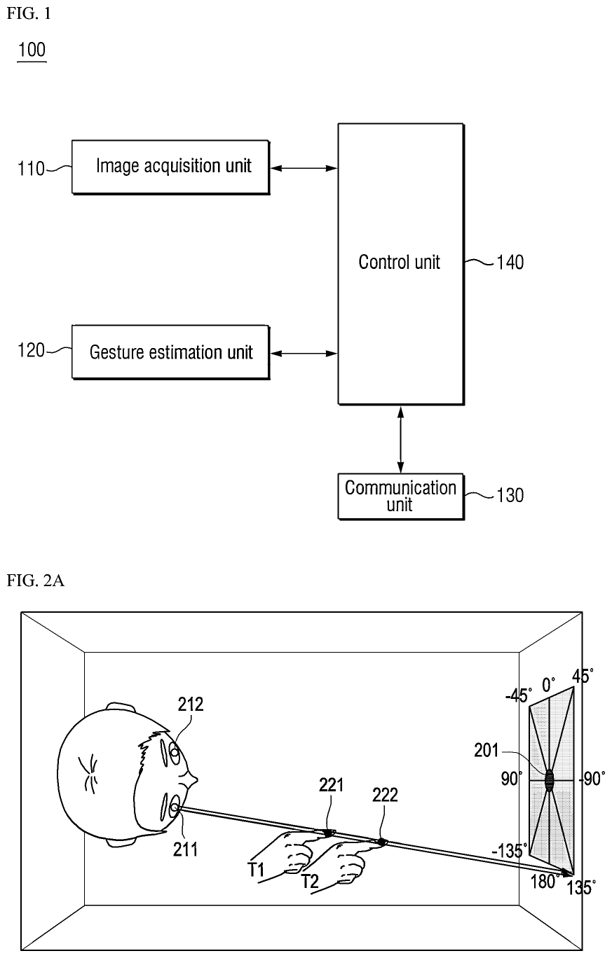

FIG. 1 illustratively shows an internal configuration of the gesture estimation system 100 according to one embodiment of the present disclosure.

As shown in FIG. 1, the gesture estimation system 100 may comprise an image acquisition unit 110, a gesture estimation unit 120, a communication unit 130, and a control unit 140. According to one embodiment of the present disclosure, at least some of the image acquisition unit 110, the gesture estimation unit 120, the communication unit 130, and the control unit 140 may be program modules configured to communicate with an external system. Such program modules may be included in the gesture estimation system 100 in the form of operating systems, application program modules, and other program modules, while they may be physically stored in a variety of commonly known storage devices. Further, the program modules may also be stored in a remote storage device that may communicate with the gesture estimation system 100. Meanwhile, such program modules may include, but not limited to, routines, subroutines, programs, objects, components, data structures, and the like for performing specific tasks or executing specific abstract data types as will be described below in accordance with the present disclosure.

First, the image acquisition unit 110 according to one embodiment of the present disclosure may function to acquire a two-dimensional image relating to a user's body from the two-dimensional camera.

For example, according to one embodiment of the present disclosure, the image acquisition unit 110 may acquire a two-dimensional image in which the user's body including an eye (e.g., both eyes or a dominant eye) which is a first body part of the user, and a fingertip (e.g., an index finger tip) which is a second body part of the user, is photographed.

Next, according to one embodiment of the present disclosure, the gesture estimation unit 120 may specify two-dimensional relative coordinate points corresponding to each of the first body part and the second body part of the user in a relative coordinate system that is dynamically defined in the two-dimensional image.

Further, according to one embodiment of the present disclosure, the gesture estimation unit 120 may compare a positional relationship between the two-dimensional relative coordinate point of the first body part and the two-dimensional relative coordinate point of the second body part at a first time point, and a positional relationship between the two-dimensional relative coordinate point of the first body part and the two-dimensional relative coordinate point of the second body part at a second time point.

Here, according to one embodiment of the present disclosure, the positional relationship between the two-dimensional relative coordinate point of the first body part and the two-dimensional relative coordinate point of the second body part may be specified by an angle between a straight line that connects the two-dimensional relative coordinate point of the first body part and the two-dimensional relative coordinate point of the second body part in the two-dimensional image, and a reference line set in the two-dimensional image. Specifically, according to one embodiment of the present disclosure, the positional relationship between the two-dimensional relative coordinate point of the first body part and the two-dimensional relative coordinate point of the second body part may be a concept that includes a length of the straight line that connects the two-dimensional relative coordinate point of the first body part and the two-dimensional relative coordinate point of the second body part in the two-dimensional image (i.e., a distance between the first body part and the second body part that appears in the two-dimensional image).

Further, according to one embodiment of the present disclosure, when the relative coordinate system dynamically defined in the two-dimensional image is a polar coordinate system dynamically defined around the two-dimensional relative coordinate point of the first body part in the two-dimensional image, the positional relationship between the two-dimensional relative coordinate point of the first body part and the two-dimensional relative coordinate point of the second body part may be determined by the two-dimensional relative coordinate point of the second body part specified in the polar coordinate system. For example, (r, θ), which is a two-dimensional relative coordinate point of the user's fingertip, may be specified as r indicating a distance from the first body part of the user to the second body part of the user and a direction angle θ of the second body part of the user with respect to a certain reference line.

Furthermore, according to one embodiment of the present disclosure, the gesture estimation unit 120 may estimate the user's gesture made between the first time point and the second time point by referring to both the context information acquired from the two-dimensional image and the result of comparing the positional relationship at the first time point and the positional relationship at the second time point.

Here, according to one embodiment of the present disclosure, the context information may include information about a change in distance between the first body part and the second body part that appear in the two-dimensional image. Further, according to one embodiment of the present disclosure, the context information may include information about a change in at least one of a size, a brightness and a pose of the second body part that appears in the two-dimensional image or other body part associated with the second body part. For example, the second body part associated with the context information may be a user's hand (or a finger), and the other body part associated with the second body part may be an arm (a forearm or an upper arm) connected with the user's hand.

As an example, when the user makes a gesture to move his/her hand forward or backward relative to the two-dimensional camera, the size of the user's hand appearing on the two-dimensional image may become larger or smaller according to the perspective, and a brightness of the user's hand appearing on the two-dimensional image may become brighter or darker as a distance between the user's hand and a light source of the two-dimensional camera changes.

Further, for example, when the user makes a gesture to move his/her hand in parallel while maintaining the distance between the two-dimensional camera and the user's hand substantially constant, a specific change may not appear in the size, brightness, or the like of the user's hand on the two-dimensional image.

As another example, when the user makes a gesture to move his/her hand forward or backward relative to a surrounding object, a distance between his/her eye and his/her hand which appears on the two-dimensional image may become larger or smaller. Further, as a posture of the user's wrist, elbow, shoulder or the like changes, a pose of the user's hand appearing on the two-dimensional image may be changed from a folded state to an extended state or from the extended state to the folded state, and a user's arm connected to the user's hand may be changed from a folded state to an extended state, or from the extended state to the folded state.

By referring to the context information illustrated as above, the gesture estimation unit 120 according to one embodiment of the present disclosure may more specifically and accurately estimate the gesture of the user as compared to a case of referring to merely the two-dimensional relative coordinate points relating to the user's body part.

Specifically, according to one embodiment of the present disclosure, when the difference between the positional relationship between the first body part and the second body part at the first time point, and the positional relationship between the first body part and the second body part at the second time point is equal to or less than a predetermined threshold level, and it is determined from the context information that the second body part gets closer to or farther away from the two-dimensional camera, the gesture estimation unit 120 may estimate that the user has made a gesture to move his/her second body part forward or backward relative to the two-dimensional camera.

As an example, when on the two-dimensional image in which the second body part of the user is photographed, a degree to which the size of the second body part increases is equal to or greater than a predetermined level, or a degree to which the brightness of the second body part becomes brighter is equal to or greater than a predetermined level, the gesture estimation unit 120 according to one embodiment of the present disclosure may determine that the second body part gets closer to the two-dimensional camera. In contrast, when on the two-dimensional image in which the second body part of the user is photographed, the degree to which the size of the second body part decreases is equal to or greater than a predetermined level, or the degree to which the brightness of the second body part becomes darker is equal to or greater than a predetermined level, the gesture estimation unit 120 according to one embodiment of the present disclosure may determine that the second body part gets farther away from the two-dimensional camera.

On the other hand, according to one embodiment of the present disclosure, when it is determined from the context information that, regardless of whether the difference between the positional relationship between the first body part and the second body part at the first time point, and the positional relationship between the first body part and the second body part at the second time point is equal to or less than the predetermined threshold level, the second body part gets closer to or farther away from the two-dimensional camera, the gesture estimation unit 120 may estimate that the user has not made the gesture to move the second body part forward or backward relative to the two-dimensional camera.

As an example, according to one embodiment of the present disclosure, when on the two-dimensional image in which the second body part of the user is photographed, the change in the size and brightness of the second body part is less than the predetermined level, the gesture estimation unit 120 may determine that the second body part does not get closer to or farther away from the two-dimensional camera, and further determine that the distance between the two-dimensional camera and the second body part is not changed significantly.

On the other hand, according to one embodiment of the present disclosure, when it is determined that the difference between the positional relationship between the first body part and the second body part at the first time point and the positional relationship between the first body part and the second body part at the second time point is equal to or less than the predetermined threshold level, and that the second body part gets closer to or farther away from a surrounding object around the user from the context information, the gesture estimation unit 120 may estimate that the user made a gesture to move the second body part forward or backward relative to the surrounding object.

As an example, when on the two-dimensional image in which the user is photographed, the degree to which the distance between the first body part and the second body part increases is equal to or greater than a predetermined level, the degree to which the arm connected to the second body part extends is equal to or greater than a predetermined level, or the degree to which the pose of the second body part is changed to the extended state is equal to or greater than a predetermined level, the gesture estimation unit 120 according to one embodiment of the present disclosure may determine that the second body part gets closer to the surrounding object. In contrast, when on the two-dimensional image in which the user is photographed, the degree to which the distance between the first body part and the second body part decreases is equal to or greater than the predetermined level, the degree to which the arm connected to the second body part extends is equal to or greater than the predetermined level, or the degree to which the pose of the second body part is changed to the folded state is equal to or greater than the predetermined level, the gesture estimation unit 120 according to one embodiment of the present disclosure may determine that the second body part gets farther away from the surrounding object.

According to one embodiment of the present disclosure, the gesture estimation unit 120 may estimate the gesture made by the user between the first time point and the second time point using a model learned based on a machine learning.

Here, according to one embodiment of the present disclosure, the learning described above may be performed using a certain machine learning. More specifically, the learning may be performed using a machine learning based on an artificial neural network. For example, various neural network algorithms such as a convolutional neural network (CNN), a recurrent neural network (RNN), an auto-encoder, or the like may be utilized to implement the above-described artificial neural network.

Further, according to one embodiment of the present disclosure, the gesture estimation system 100 may refer to the user's gesture estimated in the above manner to specify a control command intended by the user and cause the control command to be executed.

The communication unit 130 according to one embodiment of the present disclosure may function to enable data transmission/reception from/to the image acquisition unit 110 and the gesture estimation unit 120.

Lastly, the control unit 140 according to one embodiment of the present disclosure may function to control data flow among the image acquisition unit 110, the gesture estimation unit 120, and the communication unit 130. That is, the control unit 140 according to the present disclosure may control data flow into/out of the gesture estimation system 100, or data flow among respective components of the gesture estimation system 100, such that the image acquisition unit 110, the gesture estimation unit 120, and the communication unit 130 may carry out their particular functions, respectively.

### Exemplary Embodiments

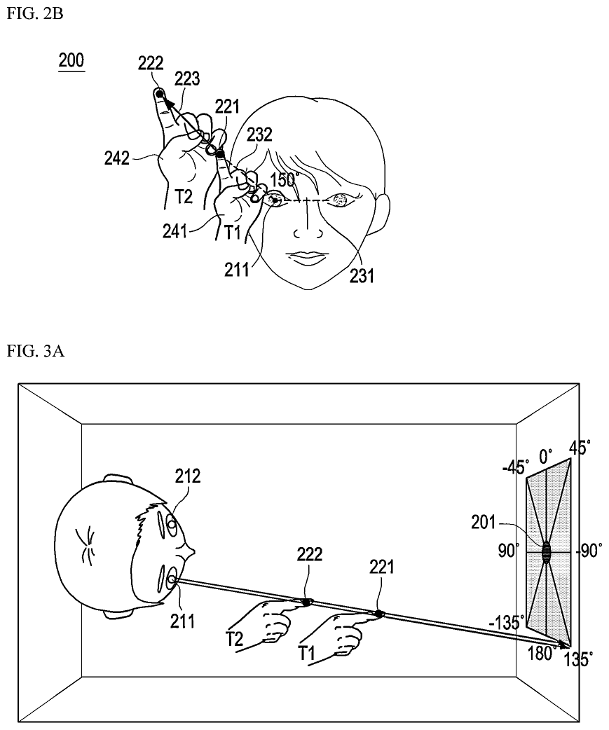

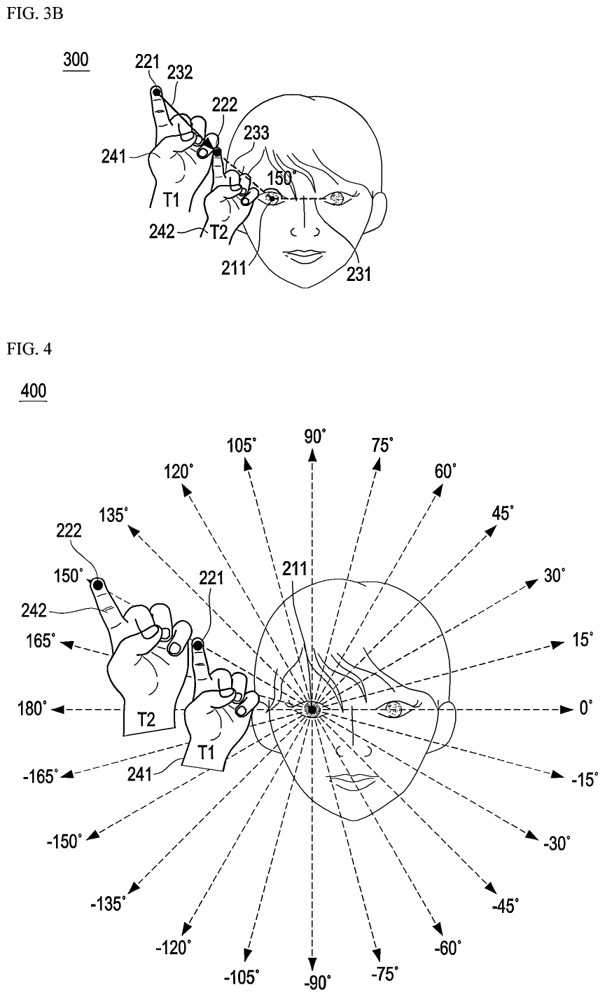

FIGS. 2 and 3 illustratively show a two-dimensional image in which a user makes a gesture with respect to a two-dimensional camera according to one embodiment of the present disclosure.

In one embodiment described with reference to FIGS. 2 and 3, it may be assumed that the user who looks at a two-dimensional camera 201 makes a gesture for an object control or a command input by moving his/her fingertip 221, 222.

Referring to FIGS. 2 and 3, the gesture estimation unit 120 according to one embodiment of the present disclosure may specify, as a positional relationship between the user's eye and his/her fingertip, an angle between a straight line 232, 233 that connects a two-dimensional relative coordinate point of an eye 211 (i.e., a first body coordinate point) of the user and a two-dimensional relative coordinate point of the fingertip 221, 222 (i.e., a second body coordinate point) of the user, which are specified on a two-dimensional image 200, 300 photographed by the two-dimensional camera 201, and a reference line set on the two-dimensional image 200, 300. In this case, according to one embodiment of the present disclosure, the reference line 231 set on the two-dimensional image 200 (or 300) may be a horizontal line (or a vertical line) specified by a horizontal axis (or vertical axis) of the two-dimensional image 200, 300, or a straight line parallel to a straight line that connects both eyes of the user on the two-dimensional image 200, 300.

In the embodiment described with reference to FIGS. 2 and 3, it may be seen that the relative positional relationship (i.e., the angle described above) between the user's eye 211 and his/her fingertip 221, 222 appearing on the two-dimensional image 200, 300 acquired from the two-dimensional camera 201 remains substantially constant without any change while the user makes a gesture to move his/her fingertip 221, 222 relative to the two-dimensional camera 201. In the embodiment of FIGS. 2 and 3, the above angle may be assumed to be kept at about 150 degrees.

Specifically, referring to FIGS. 2 and 3, the gesture estimation unit 120 according to one embodiment of the present disclosure compares a positional relationship between the user's eye 211 and his/her fingertip 221 at a first time point T1 appearing on the two-dimensional image 200, 300, and a positional relationship between the user's eye 211 and his/her fingertip 222 at a second time point T2. When it is determined that a difference between the two positional relationships is equal to or less than a predetermined threshold level (i.e., the two positional relationships are substantially constant), the gesture estimation unit 120 according to one embodiment of the present disclosure may estimate that (1) the user has most likely made a gesture to move his/her fingertip 221, 222 closer to or farther away from the two-dimensional camera 201 between the first time point and the second time point, and (2) the user has most likely made a gesture to move his/her fingertip 221, 222 in parallel while a distance between the two-dimensional camera 201 and the fingertip 221, 222 is maintained substantially constant.

Further, referring to FIGS. 2 and 3, when the positional relationship between the user's eye 211 and his/her fingertip 221 at the first time point and the positional relationship between the user's eye 211 and his/her fingertip 222 at the second time point are substantially equal to each other, the gesture estimation unit 120 according to one embodiment of the present disclosure may specifically and accurately estimate the user's gesture by further referring to the context information acquired from the two-dimensional image 200, 300.

Specifically, in the above case, (1-1) when acquiring the context information supporting that a user's hand 241, 242 gest closer to the two-dimensional camera 201, such as that on the two-dimensional image 200, the size of the user's hand 241, 242 is increased or the brightness of the user's hand 241, 242 becomes brighter, the gesture estimation unit 120 according to one embodiment of the present disclosure may estimate that the user has made a gesture to move his/her fingertip 221, 222 forward relative to the two-dimensional camera 201 between the first time point and the second time point (see FIG. 2). Further, (1-2) when acquiring the context information supporting that the user's hand 241, 242 is away from the two-dimensional camera 201, such as that on the two-dimensional image 300, the size of the user's hand 241, 242 is decreased or the brightness of the user's hand 241, 242 becomes darker, the gesture estimation unit 120 according to one embodiment of the present disclosure may estimate that the user has made a gesture to move his/her fingertip 221, 222 backward relative to the two-dimensional camera 201 between the first time point and the second time point (see FIG. 3). Furthermore, (2) when acquiring the context information supporting that a change in the distance between the user's hand and the two-dimensional camera 201 is not significant, such as that no change in the size and brightness of the user's hand occurs on the two-dimensional image 300, the gesture estimation unit 120 according to one embodiment of the present disclosure may estimate that the user has made a gesture to move his/her fingertip 221, 222 in parallel while the user maintains the distance between his/her fingertip and the two-dimensional camera 201 substantially constant between the first time point and the second time point (i.e., a gesture different from the gesture to move his/her fingertip forward or backward relative to the two-dimensional camera 201) (not shown).

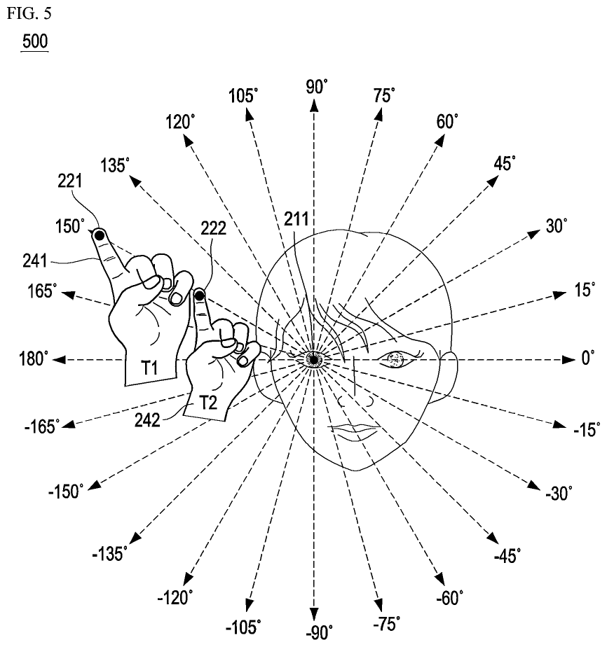

FIGS. 4 to 6 illustratively show a two-dimensional image in which the user makes a gesture with respect to the two-dimensional camera with reference to a polar coordinate system according to one embodiment of the present disclosure.

Referring to FIGS. 4 to 6, the gesture estimation unit 120 according to one embodiment of the present disclosure may specify, as a positional relationship between the user's eye 211 and his/her fingertip 221, 222, a two-dimensional relative coordinate point of the user's fingertip 221, 222 (i.e., a second body coordinate point) that is specified in a polar coordinate system dynamically defined with the user's eye 211 (i.e., a first body coordinate point) specified on a two-dimensional image 400, 500 and 600 acquired from the two-dimensional camera 201 as the center (origin point). In this case, according to one embodiment of the present disclosure, the two-dimensional relative coordinate point of the user's fingertip may be specified as r indicating a distance from the user's eye (i.e., the origin point) to the user's fingertip and a direction angle θ of the user's fingertip relative to a reference line set on the two-dimensional image 400, 500 and 600.

Specifically, referring to FIGS. 4 to 6, the gesture estimation unit 120 according to one embodiment of the present disclosure compares a direction angle of the two-dimensional relative coordinate point of the user's fingertip 221 at a first time point T1 and a direction angle of the two-dimensional relative coordinate point of the user's fingertip 222 at a second time point T2, which appear on the two-dimensional image 400, 500 and 600. When it is determined that a difference between the two direction angles is equal to or less than a predetermined threshold level (i.e., the two direction angles are substantially equal to each other), the gesture estimation unit 120 according to one embodiment of the present disclosure may estimate that (1) the user has most likely made a gesture to move his/her fingertip 221, 222 forward or backward relative to the two-dimensional camera 201 between the first time point and the second time point, and that (2) the user has most likely made a gesture to move his/her fingertip 221, 222 in parallel in a direction corresponding to the direction angle of the two-dimensional relative coordinate point of the user's fingertip 221 while a distance between the two-dimensional camera 201 and the fingertip 221, 222 is maintained substantially constant between the first time point and the second time point.

Further, referring to FIGS. 4 to 6, when the direction angle (approx. 150 degrees) of the two-dimensional relative coordinate point of the user's fingertip 221 at the first time point T1 and the direction angle (approx. 150 degrees) of the two-dimensional relative coordinate point of the user's fingertip 222 at the second time point T2 is determined to be substantially equal to each other, the gesture estimation unit 120 according to one embodiment of the present disclosure may specifically and accurately estimate the user's gesture by further referring to the context information acquired from the two-dimensional images 400, 500 and 600.

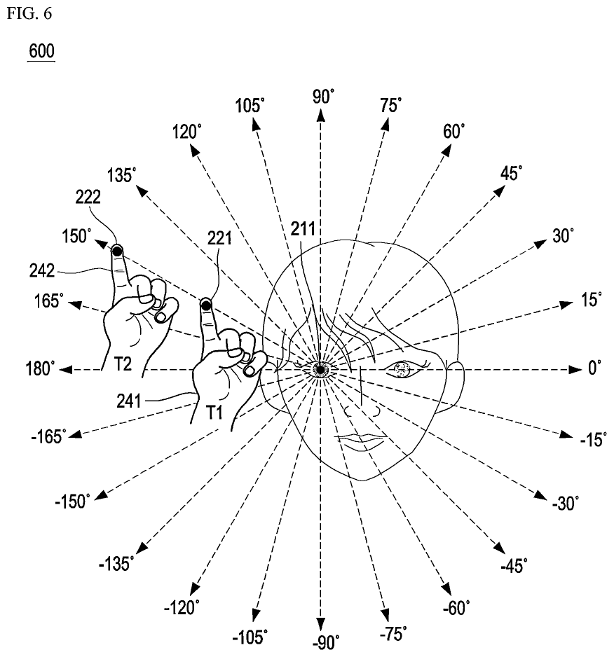

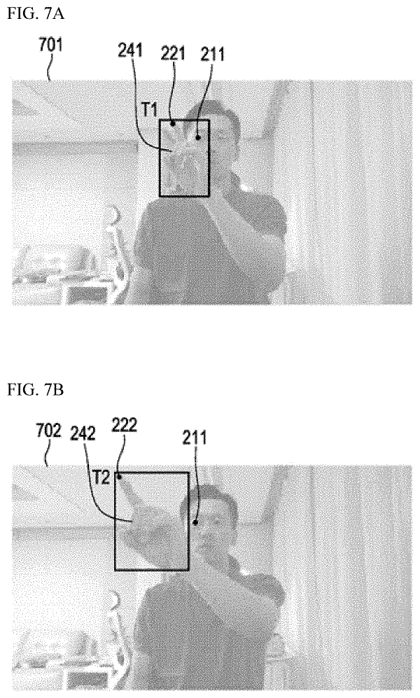

Specifically, in the above case, (1-1) when acquiring the context information supporting that the user's hand 241, 242 gets closer to the two-dimensional camera 201, such as that on the two-dimensional image 400, the size of the user's hand 241, 242 is increased or the brightness of the user's hand 241, 242 becomes brighter, the gesture estimation unit 120 according to one embodiment of the present disclosure may estimate that the user has made a gesture to move his/her fingertip 221, 222 forward relative to the two-dimensional camera 201 between the first time point and the second time point (see FIG. 4). Further, (1-2) when acquiring the context information supporting that the user's hand 241, 242 is away from the two-dimensional camera 201, such as that on the two-dimensional image 500, the size of the user's hand 241, 242 is decreased or the brightness of the user's hand 241, 242 becomes darker, the gesture estimation unit 120 according to one embodiment of the present disclosure may estimate that the user has made a gesture to move his/her fingertip 221, 222 backward relative to the two-dimensional camera 201 between the first time point and the second time point (see FIG. 5). Further, (2) when acquiring the context information supporting that a change in the distance between the user's hand and the two-dimensional camera 201 is not significant, such as that no change in the size and brightness of the user's hand occurs the two-dimensional image 600, the gesture estimation unit 120 according to one embodiment of the present disclosure may estimate that the user has made a gesture to move his/her fingertip 221, 222 in parallel while the user maintains the distance between his/her fingertip and the two-dimensional camera 201 substantially constant between the first time point and the second time point (i.e., a gesture different from the gesture to move his/her fingertip forward or backward relative to the two-dimensional camera 201) (see FIG. 6).

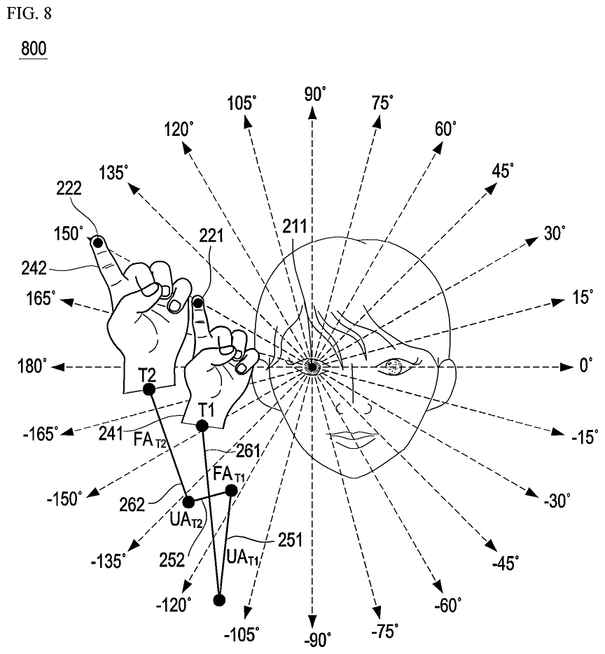

FIGS. 7A and 7B illustratively show a two-dimensional image in which the user makes a gesture to move his/her finger forward relative to the two-dimensional camera according to one embodiment of the present disclosure.

FIG. 7A illustratively shows the two-dimensional image in which the user is photographed at the first time point T1, and FIG. 7B illustratively shows the two-dimensional image in which the user is photographed at the second time point T2.

Referring to FIGS. 7A and 7B, when the user makes a gesture to move his/her fingertip 221 forward during the period of the first time point to the second time point, as a result of comparing a two-dimensional image 701 in which the user is photographed at the first time point with a two-dimensional image 702 in which the user is photographed at the second time point, it may be found that the size of the area corresponding to the user's hand 241 appearing on the two-dimensional image 701, 702 becomes larger and the brightness of the user's hand 241 becomes brighter.

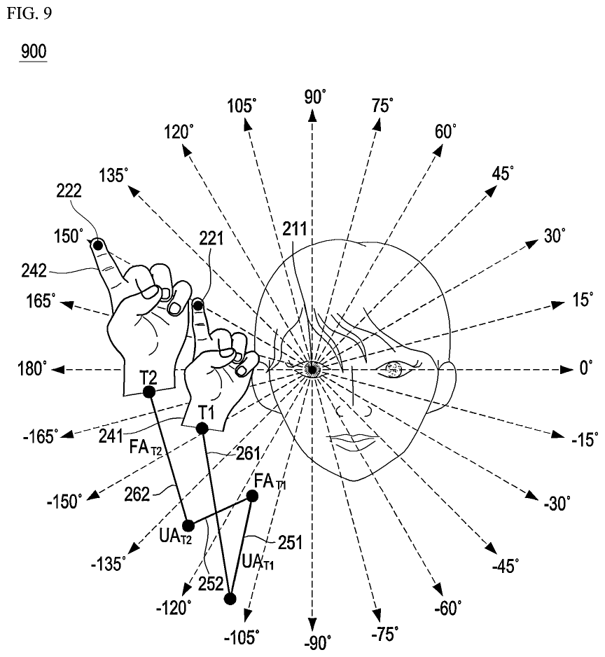

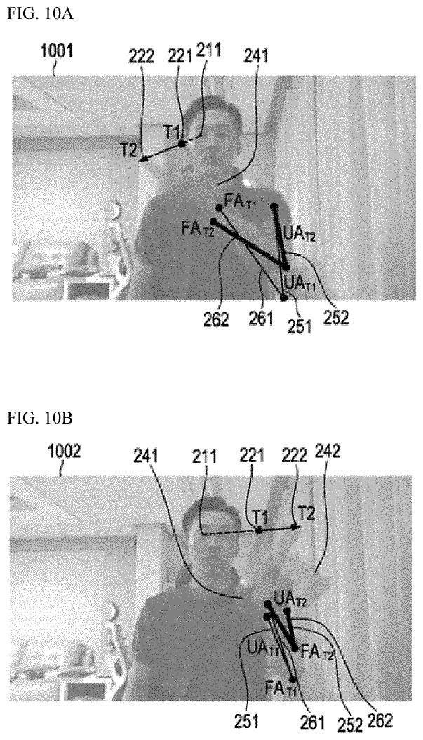

FIGS. 8 and 9 illustratively show a two-dimensional image in which the user makes a gesture with respect to a surrounding object according to one embodiment of the present disclosure.

Referring to FIGS. 8 and 9, the gesture estimation unit 120 according to one embodiment of the present disclosure may compare the direction angle of the two-dimensional relative coordinate point of the user's fingertip 221 at the first time point T1 with the direction angle of the two-dimensional relative coordinate point of the user's fingertip 222 at the second time point T2, which appear on a two-dimensional image 800, 900. When it is determined that a difference between the two direction angles is equal to or less than a predetermined threshold level (i.e., the two direction angles are substantially equal to each other), the gesture estimation unit 120 according to one embodiment of the present disclosure may estimate that the user has most likely made a gesture to move his/her fingertip 221, 222 closer to or farther away from a surrounding object (not shown) between the first time point and the second time point.

Further, referring to FIGS. 8 and 9, when it is determined that the direction angle (approx. 150 degrees) of the two-dimensional relative coordinate point of the user's fingertip 221 at the first time point T1 and the direction angle (approx. 150 degrees) of the two-dimensional relative coordinate point of the user's fingertip 222 at the second time point T2 are substantially equal to each other, the gesture estimation unit 120 according to one embodiment of the present disclosure may specifically and accurately estimate the user's gesture by further referring to context information acquired from the two-dimensional image 800, 900.

Specifically, in the above case, the gesture estimation unit 120 according to one embodiment of the present disclosure may estimate the user's gesture with reference to context information about a change in distance between the user's eye 211 and his/her fingertip 221, 222, a change in pose of the user's hand 241, 242, a change in posture of the arm connected to the user's hand 241, 242, or the like

As an example, when acquiring the context information supporting that the user's hand 241, 242 gets closer to the surrounding object (not shown), such as that on the two-dimensional image 800, the distance between the user's eye 211 and his/her fingertip 221, 222 is increased, the pose of the user's hand 241, 242 is changed to an extended state, or the arm connected to the user's hand 241, 242 is extended, the gesture estimation unit 120 according to one embodiment of the present disclosure may estimate that the user has made a gesture to move his/her fingertip 221, 222 forward relative to the surrounding object (not shown) between the first time point and the second time point.

Further, for example, when acquiring the context information supporting that the user's hand 241, 242 gets farther away from the surrounding object (not shown), such as that on the two-dimensional image 800, the distance between the user's eye 211 and his/her fingertip 221, 222) is decreased, the pose of the user's hand 241, 242 is changed to the folded state, or the arm connected to the user's hand 241, 242 is folded, the gesture estimation unit 120 according to one embodiment of the present disclosure may estimate that the user has made a gesture to move his/her fingertip 221, 222 backward relative to the surrounding object (not shown) between the first time point and the second time point.

Further, for example, when acquiring the context information supporting that a change in the distance between the user's hand 241, 242 and the surrounding object (not shown) is not significant, such as that on the two-dimensional image 900, no change in the distance between the user's eye 211 and his/her fingertip 221, 222, no change in the pose of the user's hand 241, 242, and no change in the state of the arm connected to the user's hand 241, 242 occur, the gesture estimation unit 120 according to one embodiment of the present disclosure may estimate that the user has made a gesture (e.g., a gesture to move his/her fingertip 221, 222 in parallel while maintaining a distance between the surrounding object (not shown) and his/her fingertip 221, 222 substantially constant), which is different from the gesture to move his/her fingertip 221, 222 forward or backward relative to the surrounding object (not shown) between the first time point and the second time point.

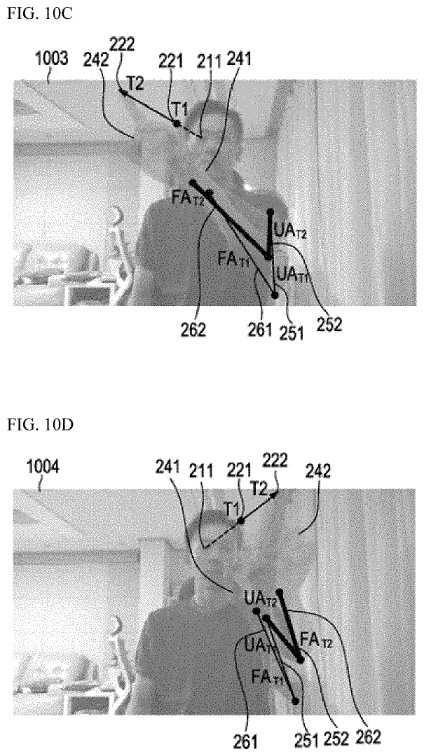

FIGS. 10A to 10D illustratively show a two-dimensional image in which a user makes a gesture to move his/her finger forward relative to a surrounding object according to one embodiment of the present disclosure.

In each of two-dimensional images 1001 to 1004 shown in FIGS. 10A to 10D, a state of the user photographed at the first time point T1 and a state of the user photographed at the second time point T2 are displayed in an overlapped manner. In the embodiment shown in FIGS. 10A to 10D, an object (not shown) to which the user makes a gesture may be located on the side of the two-dimensional camera with a position of the user as a reference.

Referring to FIGS. 10A to 10D, when the user makes a gesture to move his/her fingertip 221, 222 forward relative to a specific object (not shown) during the period of a first time point to a second time point, in a state in which the positional relationship between the two-dimensional relative coordinate point of the user's eye 211 and the two-dimensional relative coordinate point of the user's fingertip 221, 222 remains substantially constant, it may be seen that, as the arm connected to the user's hands 241, 242 extends, the arm appearing on each of the two-dimensional images 1001 to 1004 is relatively further extended.

In the embodiments described above, the user's gesture has been described to be estimated with reference to information about the positional relationship between the user's eye and his/her fingertip, which appears on the two-dimensional image in which the user is photographed, and the context information about the distance between the user's eye and his/her hand, the size, pose and brightness of the user's hand, and the change in posture of the arm (a forearm and an upper arm). However, the present disclosure is not necessarily limited to the above-described exemplary embodiments.

As an example, according to one embodiment of the present disclosure, the gesture estimation unit 120 may learn a certain classification model or an estimation model capable of estimating a user's gesture by performing a machine learning (deep learning) based on a plurality of two-dimensional images in which a user is photographed at a plurality of time points, and may estimate the user's gesture using the learned classification model or the learned estimation model.

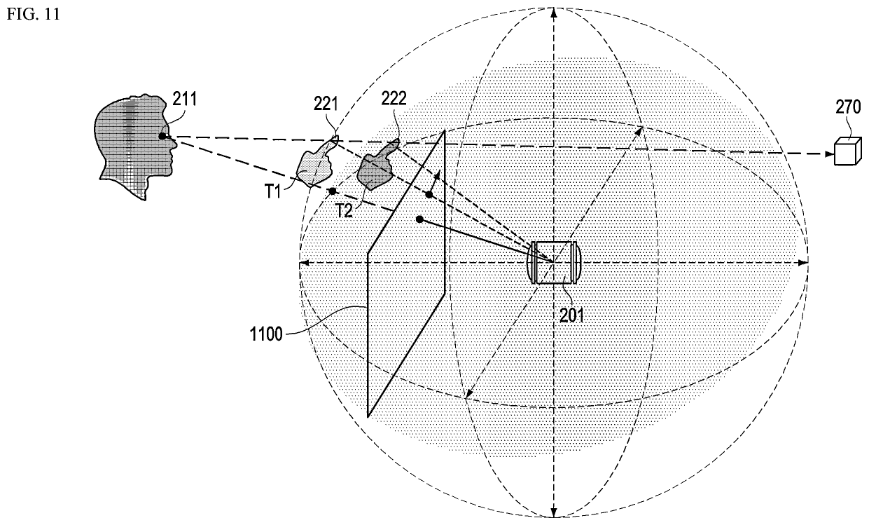

FIGS. 11 to 14 illustratively show a two-dimensional image in which a user makes a gesture with respect to a surrounding object according to one embodiment of the present disclosure.

In the embodiment of FIGS. 11 to 14, it may be assumed a case in which a user being photographed by the two-dimensional camera 201 makes a gesture to control or command input to an object 270 present in its vicinity by moving his/her fingertip 221, 222.

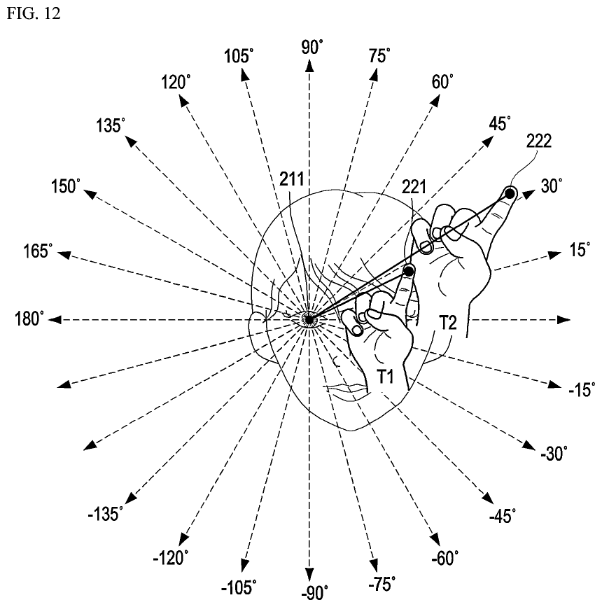

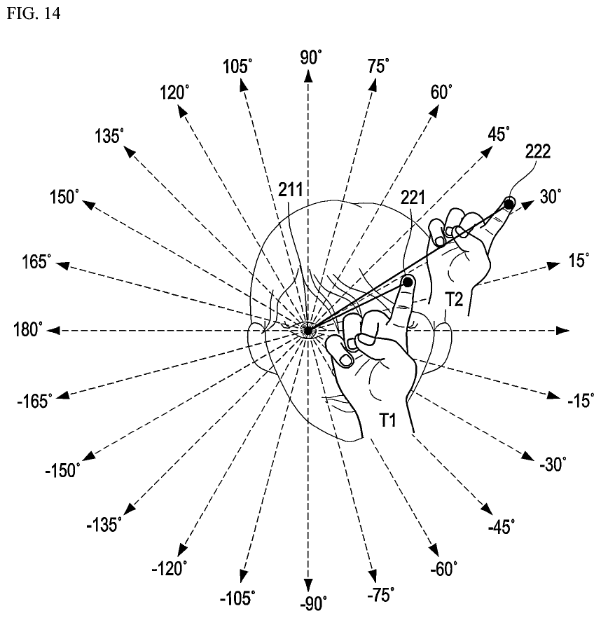

Referring to FIGS. 11 to 14, on a two-dimensional image 1100, 1300 in which the user makes a gesture to move his/her fingertip 221, 222 forward or backward relative to an object 270 with the two-dimensional camera 201 (see FIGS. 12 and 14), significant changes in the distance between the user's eye 211 and his/her fingertip 221, 222, the posture of the arm connected to the user's fingertip 221, 222, and the pose of the hand connected to the user's fingertip 221, 222 may occur. The gesture estimation unit 120 according to one embodiment of the present disclosure may estimate the user's gesture with reference to context information determined based on such changes.

Specifically, as shown in FIGS. 11 and 12, it may be assumed that a case in which the user makes a gesture to move his/her fingertip 221, 222 forward relative to an object 270 located beyond the two-dimensional camera 201 during the period of the first time point T1 to the second time point T2 (see FIG. 11). In this case, as the user extends his/her arm to move his/her fingertip 221, 222 forward relative to the object 270, on the two-dimensional image 1100 (see FIG. 12), the distance between the user's eye 211 and his/her fingertip 221, 222 may be changed to be increased, the arm connected to the user's fingertip 221, 222 may be changed to be extended, and the hand connected to the user's fingertip 221, 222 may be changed from a folded pose to an extended pose.

Further, referring to FIGS. 11 and 12, the gesture estimation unit 120 according to one embodiment of the present disclosure may estimate that the user has made the gesture to move his/her fingertip 221, 222 forward relative to the object 270 located beyond the two-dimensional camera 201 by referring to context information about the above-described changes.

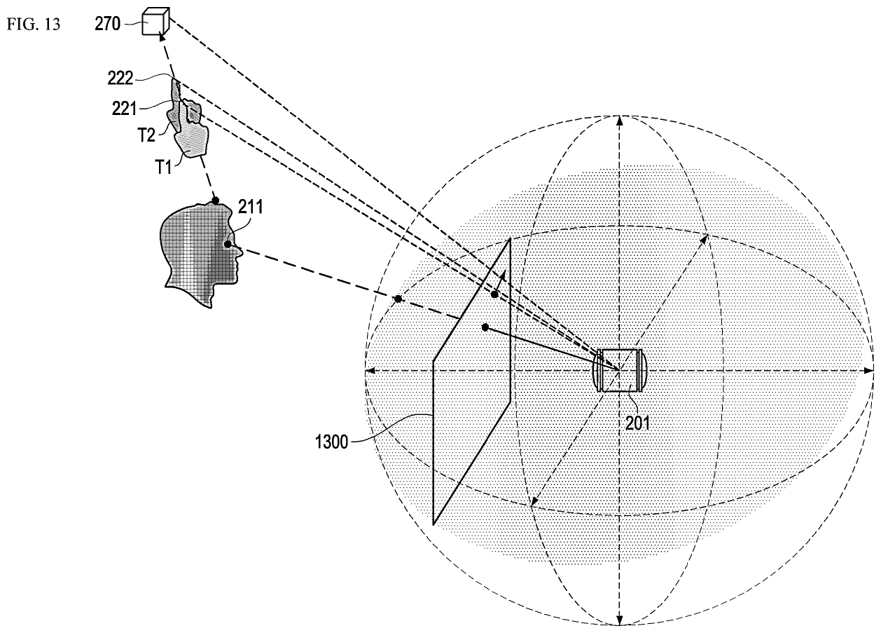

Further, as shown in FIGS. 13 and 14, it may be assumed that a case in which the user makes a gesture to move his/her fingertip 221, 222 forward relative to the object 270 located on the left side of the user during the period of the first time point T1 to the second time point T2 (see FIG. 13). In this case, as the user extends his/her arm to move his/her fingertip 221, 222 forward relative to the object 270, on the two-dimensional image 1300 (see FIG. 14), the distance between the user's eye 211 and his/her fingertip 221, 222 may be changed to be increased, the arm connected to the user's fingertip 221, 222 may be changed to be extended, and the hand connected to the user's fingertip 221, 222 may be changed from the folded pose to the extended pose.

Further, referring to FIGS. 13 and 14, the gesture estimation unit 120 according to one embodiment of the present disclosure may estimate that the user has made the gesture to move his/her fingertip 221, 222 forward relative to the object 270 located on the left side of the user by referring to context information about the above-described changes.

The embodiments according to the present disclosure as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present disclosure, or may also be well known and available to those skilled in the computer software field. Examples of the non-transitory computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present disclosure, and vice versa.

Although the present disclosure has been described above in terms of specific items such as detailed components as well as the limited embodiments and the drawings, they are only provided to help more general understanding of the present disclosure, and the present disclosure is not limited to the above embodiments. It will be appreciated by those skilled in the art to which the present disclosure pertains that various modifications and changes may be made from the above description.

Therefore, the spirit of the present disclosure shall not be limited to the above-described embodiments, and the entire scope of the appended claims and all equivalent will fall with the scope and spirit of the present disclosure.

What is claimed is:

1. A method of estimating a gesture of a user from a two-dimensional image, comprising the steps of:
acquiring a two-dimensional image relating to a user's body from a two-dimensional camera;
specifying two-dimensional relative coordinate points corresponding to a first body part and a second body part of the user in a relative coordinate system dynamically defined in the two-dimensional image, and comparing a first positional relationship between the two-dimensional relative coordinate point of the first body part and the two-dimensional relative coordinate point of the second body part at a first time point, and a second positional relationship between the two-dimensional relative coordinate point of the first body part and the two-dimensional relative coordinate point of the second body part at a second time point; and
estimating the gesture made by the user between the first time point and the second time point with reference to a result of the comparing and context information acquired from the two-dimensional image.

2. The method of claim 1, wherein each of the first positional relationship and the second positional relationship is specified by an angle between a straight line connecting the two-dimensional relative coordinate point of the first body part and the two-dimensional relative coordinate point of the second body part on the two-dimensional image, and a reference line set on the two-dimensional image.

3. The method of claim 1, wherein the relative coordinate system is a polar coordinate system dynamically defined about the two-dimensional relative coordinate point of the first body part on the two-dimensional image, and
wherein each of the first positional relationship and the second positional relationship is determined by the two-dimensional relative coordinate point of the second body part specified in the polar coordinate system.

4. The method of claim 1, wherein the context information includes information about at least one of a change in distance between the first body part and the second body part, which appear on the two-dimensional image, and a change in size, brightness, or pose of the second body part or other body part associated with the second body part, which appear on the two-dimensional image.

5. The method of claim 4, wherein in the estimating step, when a difference between the first positional relationship at the first time point and the second positional relationship at the second time point is equal to or less than a predetermined threshold level, and when it is determined that the second body part gets closer to or farther away from the two-dimensional camera during a period of the first time point to the second time point based on the context information, it is estimated that the user has made the gesture to move the second body part forward or backward relative to the two-dimensional camera.

6. The method of claim 5, wherein in the estimating step, when a degree to which the size of the second body part appearing on the two-dimensional image becomes larger is equal to or greater than a first predetermined level during the period of the first time point to the second time point, or when a degree to which the brightness of the second body part appearing on the two-dimensional image becomes brighter is equal to or greater than a second predetermined level, it is determined that the second body part gets closer to the two-dimensional camera.

7. The method of claim 5, wherein in the estimating step, when a degree to which the size of the second body part appearing on the two-dimensional image becomes smaller is equal to or greater than a third predetermined level during the period of the first time point to the second time point, or when a degree to which the brightness of the second body part appearing on the two-dimensional image becomes darker is equal to or greater than a fourth predetermined level during the period of the first time point to the second time point, it is determined that the second body part gets farther away from the two-dimensional camera.

8. The method of claim 4, wherein in the estimating step, when a difference between the first positional relationship at the first time point and the second positional relationship at the second time point is equal to or less than a predetermined threshold level, and when it is determined that the second body part gets closer to or farther away from an object located around the user during a period of the first time point to the second time point based on the context information, it is estimated that the user has made the gesture to move the second body part forward or backward relative to the object.

9. The method of claim 8, wherein in the estimating step, when a degree to which the distance between the first body part and the second body part appearing on the two-dimensional image is increased is equal to or greater than a fifth predetermined level during the period of the first time point to the second time point, when a degree to which an arm connected to the second body part of the user appearing on the two-dimensional image is extended is equal to or greater than a sixth predetermined level during the period of the first time point to the second time point, or when a degree to which a pose of the second body part of the user appearing on the two-dimensional image is changed to an extended state is equal to or greater than a seventh predetermined level during the period of the first time point to the second time point, it is determined that the second body part of the user gets closer to the object.

10. The method of claim 8, wherein in the estimating step, when a degree to which the distance between the first body part and the second body part appearing on the two-dimensional image is decreased is equal to or greater than an eight predetermined level during the period of the first time point to the second time point, when a degree to which an arm connected to the second body part of the user appearing on the two-dimensional image is folded is equal to or greater than a ninth predetermined level, or when a degree to which a pose of the second body part of the user appearing on the two-dimensional image is changed to a folded state is equal to or greater than a tenth predetermined level, it is determined that the second body part of the user gets farther away from the object.

11. The method of claim 1, wherein in the estimating step, a model learned based on a machine learning is used to estimate the gesture made by the user between the first time point and the second time point.

12. A non-transitory computer-readable recording medium having stored there on a computer program for executing the method of claim 1.

13. A system for estimating a gesture of a user from a two-dimensional image, comprising:
an image acquisition unit configured to acquire the two-dimensional image relating to the user's body from a two-dimensional camera; and
a gesture estimation unit configured to: specify two-dimensional relative coordinate points corresponding to a first body part and a second body part of the user in a relative coordinate system dynamically defined in the two-dimensional image; compare a first positional relationship between the two-dimensional relative coordinate point of the first body part and the two-dimensional relative coordinate point of the second body part at a first time point, and a second positional relationship between the two-dimensional relative coordinate point of the first body part and the two-dimensional relative coordinate point of the second body part at a second time point; and estimate the gesture made by the user between the first time point and the second time point with reference to a result of the comparing and context information acquired from the two-dimensional image.
